(19) United States
(12) Patent Application Publication
(10) Pub. No.: US 2026/0091875 A1
(43) Pub. Date: Apr. 2, 2026

(54) ONE-WAY AIRCRAFT CHARGING COMMUNICATION PROTOCOL

(71) Applicant: Joby Aero, Inc., Santa Cruz, CA (US)

(72) Inventors: Alexander Bondarenko, San Francisco, CA (US); Stéphane Lee, Mountain View, CA (US)

(21) Appl. No.: 19/345,211

(22) Filed: Sep. 30, 2025

Related U.S. Application Data
(60) Provisional application No. 63/701,986, filed on Oct. 1, 2024.

(51) Int. Cl. B64D 27/357; B64D 27/34; B64F 5/60; G07C 5/00; H01M 10/42; H01M 10/44; H01M 10/48; H01M 10/625; H01M 10/633; H02J 7/00

(52) U.S. Cl. CPC B64D 27/357; B64D 27/34; B64F 5/60; G07C 5/008; H01M 10/4221; H01M 10/425; H01M 10/44; H01M 10/48; H01M 10/625; H01M 10/633; H01M 2010/4271; H01M 2010/4278; H01M 2220/20; H02J 7/933

(57) ABSTRACT

Examples relate to a method for managing aircraft charging through a one-way communication channel. This method involves battery ground support equipment (BGSE) receiving operational data transmitted from an aircraft via a one-way communication channel. The operational data may include limit data specifying temperature, charge, and current limits. The BGSE interprets the received operational data to autonomously determine charging parameters for the aircraft and charges the aircraft based on these parameters without sending data back to the aircraft.

### CROSS-REFERENCE TO RELATED APPLICATION

This patent application claims the benefit of U.S. Provisional Ser. No. 63/701,986, filed Oct. 1, 2024, which is incorporated by reference herein in its entirety.

### BACKGROUND

In the field of electric aviation, particularly in the charging of electric aircraft, there are security and technical challenges. These challenges stem from the complexities of data communication between aircraft and battery ground support equipment, which must ensure secure and efficient handling of diverse system specifications and software versions.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating a one-way communication system for aircraft charging, showing the flow of data from the aircraft to the battery ground support equipment and the various data types managed by the system, according to some examples.

FIG. 2 is a schematic diagram illustrating the components of battery ground support equipment designed to provide charging and other support services to electric-powered aircraft, according to some examples.

FIG. 3 is a flowchart illustrating a method of managing aircraft charging through a one-way communication protocol, detailing the steps from data collection on the aircraft to the execution of the charging process by the battery ground support equipment, according to some examples.

FIG. 4 is a flowchart illustrating a method for managing aircraft charging systems, according to some examples.

FIG. 5 is an interaction diagram detailing the interactions among different components and systems involved in aircraft charging, highlighting the processes of data transmission, interpretation, and the subsequent actions taken by the battery ground support equipment, according to some examples.

FIG. 6 is a plan view of an aircraft, according to some examples.

FIG. 7 is a schematic view of an aircraft energy storage system, according to some examples.

FIG. 8 illustrates a diagrammatic representation of a machine in the form of a computer system within which a set of instructions may be executed for causing the machine to perform any one or more of the methodologies discussed herein, according to some examples.

### DETAILED DESCRIPTION

### Overview

The described examples include a one-way communication protocol designed to manage the charging of electric aircraft. This technology seeks to address several challenges associated with traditional two-way communication systems used in aviation, particularly around security, efficiency, and compatibility.

In traditional systems, both the aircraft and battery ground support equipment (BGSE) can send and receive information. This bidirectional flow allows for dynamic interaction but also introduces complexities such as the need for continuous handshaking and error correction, which can delay operations. Moreover, the two-way nature increases security risks, as it potentially allows for unauthorized access to the aircraft's control systems.

The described examples simplify this by implementing a one-way communication protocol. Here, the aircraft only sends data to the BGSE without receiving any. This approach reduces the potential attack vectors for cyber threats and simplifies the communication process, eliminating the need for handshaking and constant error checking. The aircraft functions solely as a sender, using a data transmitter to send serialized operational data, including battery status and charging requirements, to the BGSE. The BGSE, equipped with a data receiver, deserializes and interprets this data to manage the charging process effectively.

The technology employs structured data serialization methods over connectionless communication protocols to facilitate efficient data transfer. Examples of such serialization methods include Protocol Buffers (Proto Buff), developed by Google, and other formats like Apache Thrift or JSON for structured data serialization. These methods are language-neutral and platform-neutral, enhancing their versatility across various systems.

For the communication protocols, the User Datagram Protocol (UDP) may be used, known for its low latency and ability to transmit data packets without the need for establishing a connection, thereby accelerating the communication process. Other protocols like Datagram Congestion Control Protocol (DCCP) or Stream Control Transmission Protocol (SCTP) could also be utilized, offering different balances of speed, reliability, and overhead, depending on system requirements. These protocols complement the serialization methods by streamlining the data flow between the aircraft and battery ground support equipment.

Operationally, a battery management system, located within the aircraft, gathers and processes various operational data, such as battery status and charging requirements. This data is then serialized and transmitted to the BGSE. The BGSE includes a charging station controller and safety interlocks to ensure that the charging process adheres to safety standards and operational parameters set by the received data.

The BGSE also features a thermal conditioning system, which manages the battery's temperature during charging.

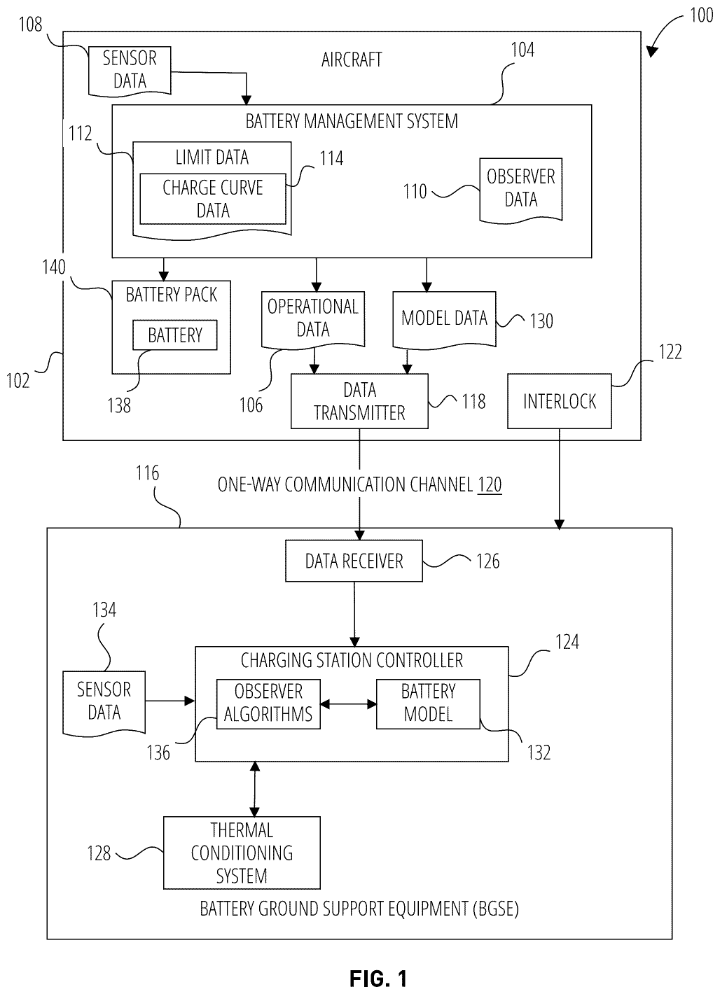

### FIG. 1

FIG. 1 is a system diagram showing a detailed view of an aircraft battery management and charging system 100, according to some examples.

The aircraft 102 contains a battery management system 104 that gathers and processes various operational data 106 related to the aircraft 102. This data includes parameters used to efficiently and safely charge one or more batteries 138 of battery packs 140 of the aircraft 102.

The operational data 106 encompasses several types of information. First, sensor data 108 delivers real-time readings from multiple sensors installed throughout the aircraft 102, providing insight into various system statuses. In addition, observer data 110 is generated by predictive models within the battery management system 104, offering estimates of battery states of the batteries 138 that cannot be measured directly. The system 100 also uses limit data 112, which defines specific operational boundaries such as temperature and charge limits for the batteries 138. Integral to limit data is charge curve data 114, which outlines allowable charging rates corresponding to a state of charge of one or more batteries 138. Together, these data types enable the battery management system 104 to manage charging safety and efficiency.

The battery management system 104 transmits the collected and generated operational data 106 to the battery ground support equipment (BGSE) 116. This transmission process involves the data transmitter 118, which serializes the data using methods such as protocol buffers or other structured data serialization tools like Thrift, Avro, or JSON.

The serialized data is sent over a one-way communication channel 120. This unidirectional communication setup allows the aircraft 102 to function solely as a data sender, enhancing the system's security by reducing potential attack vectors.

The aircraft 102 has one or more interlocks 122 that function as safety mechanisms to prevent charging when certain conditions are not met. These interlocks 122 are controlled by the battery management system 104 on the aircraft 102 and are designed to activate if the operational data 106 indicates unsafe charging conditions.

In addition to their safety function, the interlocks 122 also communicate interlock data to the battery ground support equipment (BGSE) 116. This communication may occur through the one-way communication channel 120, which allows the aircraft to transmit data to the battery ground support equipment (BGSE) 116 without receiving any data in return.

The interlock data communicated by the interlocks 122 may include their current status (e.g., engaged or disengaged) and the reason for their activation if they have been triggered.

The battery ground support equipment (BGSE) 116 receives this interlock data along with other operational data through its data receiver 126. The charging controller 124 then interprets this data as part of an overall assessment of the aircraft's status and charging readiness. This allows the battery ground support equipment (BGSE) 116 to be aware of any safety-related interruptions in the charging process initiated by the aircraft's systems, even though it cannot directly control the interlocks 122.

The battery ground support equipment (BGSE) 116 is equipped with a data receiver 126, which receives the serialized data transmitted by the aircraft 102. Upon receiving the data, the data receiver 126 deserializes it to convert it back into a usable form. The deserialized data is then ingested by the charging controller 124, which interprets the operational data to autonomously determine the charging parameters.

The battery ground support equipment (BGSE) 116 also includes a thermal conditioning system 128, which is interfaced with the charging controller 124. The thermal conditioning system 128 manages the temperature of the batteries 138 during charging through a coolant circuit between the battery ground support equipment (BGSE) 116 and the aircraft 102, ensuring that the batteries 138 remain within safe operational limits. The thermal conditioning system 128 may include components such as chillers, pumps, and coolant reservoirs, which work together to maintain the optimal temperature of the battery.

The battery management system 104 may also access and store model data 130, regarding one or more battery models, applicable to the batteries 138 of the battery packs 140 of the aircraft 102. The battery management system 104 may provide this model data 130 to the data transmitter 118 for transmission over the one-way communication channel 120 to the battery ground support equipment (BGSE) 116. In some examples, model data 130 comprises an actual battery model or battery model identification data, using which the battery ground support equipment (BGSE) 116 can identify, retrieve, and configure appropriate battery models 132 within the charging controller 124.

Expanding on this, the transmission of model data 130 enables the battery ground support equipment (BGSE) 116 to control the charging process according to the specific characteristics and requirements of the battery packs 140. The model data 130 can include detailed descriptions of the electrochemical properties, thermal behavior, charge acceptance rates, and degradation patterns under various operational conditions of the batteries 138 included in the battery packs 140.

In some examples, battery model(s) included in the model data 130 may consist of mathematical equations or algorithms that describe the battery's behavior. These models may be developed using empirical testing and characterization of the battery cells and are used to predict how the battery will respond to different charging strategies. For instance, a battery model might predict how the battery's voltage will change as a function of the charge current and temperature, which is useful for preventing overcharging and enhancing battery life.

In some examples, the model data 130 includes battery model identification data, and the BGSE 116 uses this data to access a database or a cloud-based repository where multiple battery models are stored. This identification data may be a unique identifier or a set of parameters that describe the type, capacity, and manufacturer of one or more batteries 138.

Once the appropriate model is identified, the BGSE 116 retrieves the model and configures the charging controller 124 to use this model during the charging process. This capability is useful in environments like airports, where multiple types of aircraft with different battery systems might be serviced.

The integration of battery models 132 within the charging controller 124 allows for adaptive charging strategies. Based on the input from the battery management system 104, the charging controller 124 can adjust the charging parameters in real-time to optimize charging efficiency and battery health. For example, if the battery model indicates that the battery's optimal charging temperature range shifts under certain load conditions, the BGSE 116 can adjust the thermal management strategies accordingly.

By leveraging detailed model data 130 in this way, the BGSE 116 ensures that each aircraft's battery packs 140 are charged in a manner that is not only safe and efficient but also tailored to extend the lifespan and performance of the battery based on its characteristics. This approach minimizes the risk of battery damage due to inappropriate charging techniques and maximizes the operational readiness of the aircraft 102.

The charging controller 124 may receive BGSE sensor data 134 from various sensors throughout the battery ground support equipment (BGSE) 116. Additionally, the charging controller 124 may execute local observer algorithms 136 to provide estimates of operating conditions on the aircraft 102 and within the battery ground support equipment (BGSE) 116.

The BGSE sensor data 134 received by the charging controller 124 may include general measurements such as temperature, voltage, and current from different components of the battery ground support equipment (BGSE) 116. This data helps in monitoring the overall status and performance of the charging infrastructure. The local observer algorithms 136, on the other hand, use this data to estimate conditions that are not directly measurable but are inferred from the available sensor inputs.

In some examples, the BGSE sensor data 134 may include detailed readings from thermal sensors placed near components of the battery ground support equipment (BGSE) 116. These sensors might measure ambient temperatures and the temperatures of specific components of the BGSE 116 to ensure they operate within safe thermal thresholds. Voltage sensors may track the voltage levels across various points of the battery ground support equipment (BGSE) 116 to prevent overvoltage conditions. Current sensors may also monitor the flow of electricity to ensure that the charging current remains within the designed limits for safe and efficient charging.

In some examples, the local observer algorithms 136 executed by the charging controller 124 might include algorithms designed to predict and estimate conditions within the battery packs 140 of the aircraft 102. These algorithms may also use temperature data from multiple points along with charging current and voltage data to predict potential overheating scenarios. Another observer algorithm might estimate the degradation rate of the battery pack 140 based on historical charging data and current charging behavior, helping in predictive maintenance and optimizing the charging schedule to extend the battery's lifespan.

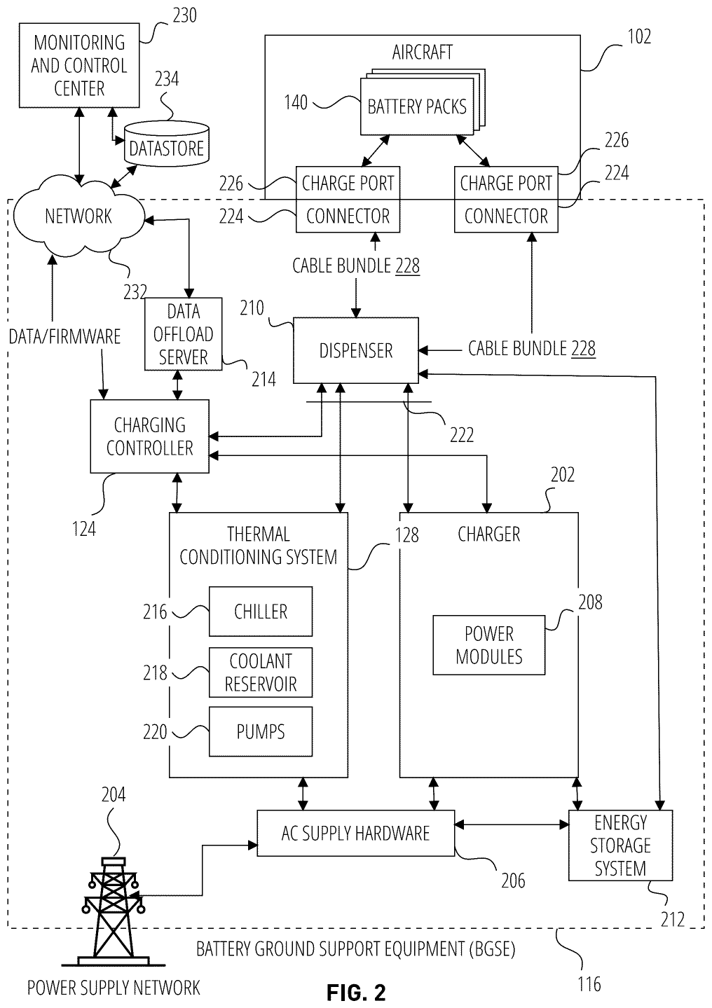

### FIG. 2: Battery Ground Support Equipment System for Electric-Powered Aircraft

FIG. 2 is a schematic diagram that shows further details of the battery ground support equipment (BGSE) 116, according to some examples, which is designed to provide charging and other support services to multiple electric-powered aircraft 102. The battery ground support equipment (BGSE) 116 is engineered to facilitate rapid charging of the battery packs 140 of the electric aircraft 102, thereby enhancing the efficiency and operational readiness of the aircraft.

The battery ground support equipment (BGSE) 116 comprises several components, including a charger 202 that receives electrical energy from a power supply network 204, via AC supply hardware 206, and distributes it to charge the battery packs 140 of the aircraft 102. The charger 202 is designed with a modular architecture that can be configured for different aircraft battery configurations, thereby providing flexibility and adaptability in its operation.

The charger 202 includes multiple power modules 208 that allow for the independent charging of each of the multiple isolated and redundant battery packs 140 in the aircraft 102. This independent charging capability ensures that each battery pack 140 receives the appropriate amount of charge based on its specific requirements, thereby improving the charging process and enhancing the overall efficiency of the battery ground support equipment (BGSE) 116. The power modules 208 communicate with the dispenser 210 for control and coordination purposes.

The battery ground support equipment (BGSE) 116 may also incorporate a ground-based energy storage system 212. This energy storage system 212 is connected to the power supply network 204, enabling it to receive electrical power efficiently. The connection to the power supply network 204 is facilitated via the AC supply hardware 206.

The ground-based energy storage system 212 serves as a backup power source, storing electrical energy that can be used to charge the aircraft's battery packs 140 when the power supply network 204 is unavailable or insufficient. This feature enhances the reliability and resilience of the ground support equipment (GSE) 116, ensuring that charging operations can continue uninterrupted even during power supply network 204 disruptions.

The ground-based energy storage system 212 also contributes to the overall efficiency of the ground support equipment (GSE) 116. It can store electrical energy during off-peak hours when electricity rates are lower, and then use this stored energy to charge the aircraft's battery packs 140 during peak hours. This approach helps reduce the overall energy costs of the ground support equipment (GSE) 116.

In some examples, the ground-based energy storage system 214 may employ peak shaving techniques to further reduce energy costs. Peak shaving involves using stored energy during periods of high electricity demand to reduce the load on the power supply network 204, potentially lowering demand charges and overall energy expenses.

Additionally, in some examples, the ground-based energy storage system 214 may use a DC microgrid-style energy storage system. This configuration can offer benefits such as improved efficiency, enhanced integration of renewable energy sources, and increased resilience against grid disturbances. A DC microgrid can also simplify power conversion processes, potentially reducing energy losses and improving overall system performance.

A thermal conditioning system 128 operatively maintains the health and longevity of the battery packs 140 by thermally conditioning them during the charging process. The thermal conditioning system 128 is designed to manage the heat generated by the battery packs 140 during charging, so that they remain within an operating temperature range.

The chiller 216 chills coolant fluid to a specific temperature. This chilled coolant fluid is then stored in a coolant reservoir 218, ready to be circulated through the battery packs 140 during the charging process.

The circulation of the coolant fluid is facilitated by pumps 220. These pumps 220 draw the chilled coolant fluid from the coolant reservoir 218 and circulate it through hoses that are part of a cable bundle 222. A cable bundle 222 is a network of hoses and cables that connect the various components of the battery ground support equipment (BGSE) 116 and the aircraft 102. The cable bundle 222 is designed to facilitate the efficient transfer of coolant fluid, electrical charge, and data between the BGSE 116 and the aircraft 102.

The coolant fluid is circulated to an internal cooling system of the aircraft 102 via connectors 224, which may include charge handles that couple to corresponding charge ports 226 of the aircraft 102. These connectors 224 facilitate the transfer of coolant fluid between the battery ground support equipment (BGSE) 116 and the aircraft 102, and form a shared coolant loop that enables fast battery cooling during charging.

Dispensers 210 provide structural support and are coupled to a charging controller 124 that regulates the power and coolant flow to the aircraft 102. A single charging controller 124 may be associated with and controls a single dispenser 210 or multiple dispensers 210 and cable bundle 222 combinations. The connectors 224, which may include charge handles, connect to the aircraft's charge ports 226 to facilitate the exchange of data, charge, and coolant between the battery ground support equipment (BGSE) 116 and the aircraft 102. The cable bundle 222 routes the power, coolant, and data connections from the charger 202, chiller 216, and coolant reservoir 218 to the dispensers 210 and, ultimately, to the connectors 224.

Additional cable bundles 228 extend these connections to the connectors 224. The dispensers 210 may also be equipped with docks specifically designed to accommodate the connectors 224 and stow the connectors 224 when not in active use.

The charging controller 124 monitors and controls multiple components of the battery ground support equipment (BGSE) 116. The charging controller 124 ensures the exchange of data, charge, and coolant to the aircraft 102 while maintaining safe operating temperatures and conditions. The charging controller 124 also controls thermal conditioning and charging processes based on feedback from the battery packs 140.

The charging controller 124, which may be housed within the dispenser 210, is responsible for the direct management of the charging process at an individual system level. It orchestrates the operation of one or more dispensers 210. Each dispenser 210 may be equipped with a send pump that actively sends coolant to the aircraft, complemented by another extract pump that extracts the coolant, thereby maintaining a regulated flow for thermal management during the charging cycle.

Beyond the dispenser 210, there may be a higher-level charge site controller that oversees multiple charging stations. This site-level controller is tasked with managing power distribution and scheduling across various chargers. It may operate as a central hub that coordinates the activities of individual charging stations, taking into account inputs from the aircraft, the dispensers, and broader operational requirements.

A data offload server 214 collects and manages data related to the charging operations at the BGSE 116. This data includes telemetry data from the aircraft 102, status data from BGSE 116 components like the thermal conditioning system 128, and information on the charging sessions. The data offload server 214 stores and aggregates the data it collects from the various subsystems of the BGSE 116 and the aircraft 102. The data offload server 214 may thus act as a data buffer for this data, and can offload or transfer the charging operations data to other systems for purposes such as monitoring, analytics, scheduling, and other applications.

The battery ground support equipment (BGSE) 116 is linked to a monitoring and control center 230 via a network 232. The monitoring and control center 230 is equipped with monitoring capabilities that allow it to track the status of various operations and components of the battery ground support equipment (BGSE) 116 in real-time. This real-time monitoring capability allows the monitoring and control center 230 to adjust the charging process as and when they are deemed to be beneficial. These adjustments may include modifying the charging rate, altering the power distribution among the battery packs, or even pausing the charging process if anomalies are detected.

By continuously monitoring the charging process and making appropriate adjustments, the monitoring and control center 230 ensures that the battery packs 140 are charged in a manner that increases their performance and longevity. This not only enhances the operational readiness of the aircraft but also contributes to the overall lifespan of the battery packs 140, thereby reducing maintenance costs and downtime. Furthermore, the monitoring and control center 230 plays a role in ensuring the safety of the charging operations. By continuously monitoring the charging process, the monitoring and control center 230 can detect anomalies or potential issues that may arise during charging. This early detection capability allows the monitoring and control center 230 to take prompt action to mitigate any risks, thereby ensuring the safety of the charging operations and the integrity of the battery packs 140.

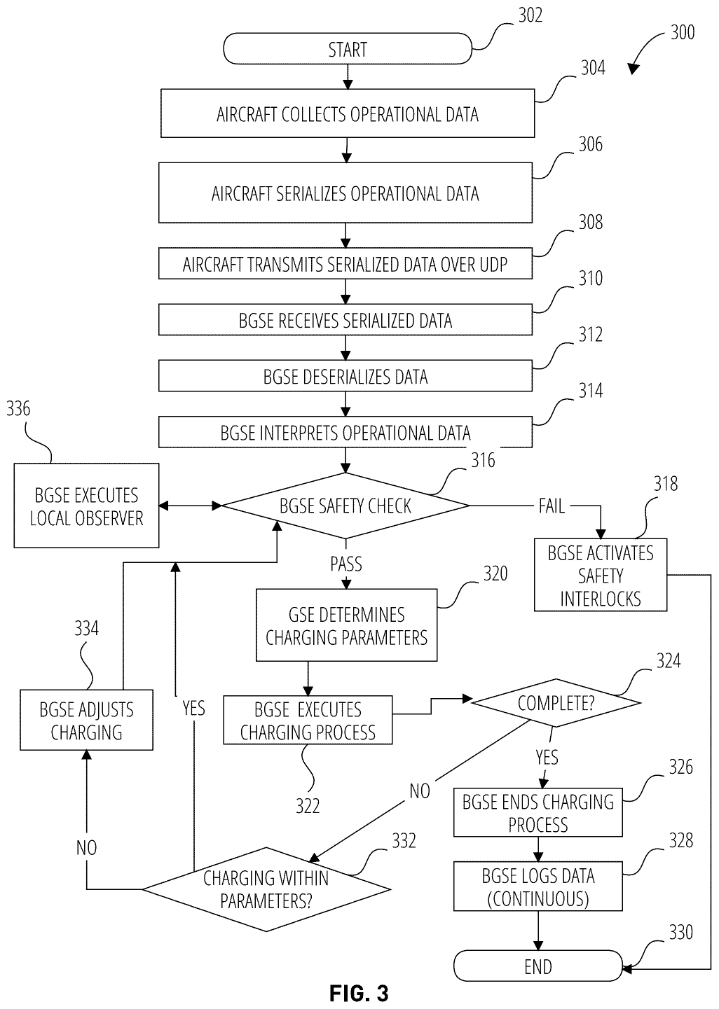

### FIG. 3

FIG. 3 is a flowchart illustrating a method 300, according to some examples, of managing aircraft charging through a one-way communication protocol.

Although the example method 300 depicts a particular sequence of operations, the sequence may be altered without departing from the scope of the present disclosure. For example, some of the operations depicted may be performed in parallel or in a different sequence that does not materially affect the function of the method 300. In some examples, different components of an example device or system that implements the method 300 may perform functions at substantially the same time or in a specific sequence.

At block 302, the method 30 starts and, at block 304, the aircraft 102 collects operational data. As noted with respect to FIG. 1, the operational data 106 may include both sensor data 108 (including observer data 110) and limit data 112 (including, for example, charge curve data 114). At a high level, the process at block 304 involves the collection and storage of data that informs the status and operational readiness of the aircraft's battery system. This data management is facilitated by the battery management system 104, which acts as a hub for data aggregation.

For example, the battery management system 104 may process incoming sensor data 108, which may include voltage levels, current flow, and temperature readings from various sensors embedded within the battery and the aircraft's systems.

The sensor data 108 processed by the battery management system 104 may include detailed measurements such as the rate of charge or discharge, impedance measurements, and thermal imaging data of the battery cells. For instance, impedance measurements help detect abnormalities in the battery cells of the battery packs 140 that could indicate potential failures. Thermal imaging may be used to pinpoint hot spots within the battery packs 140.

Additionally, the battery management system 104 may receive and process sensor data 108, which may encompass observer data 110, which is derived from observer models predicting unmeasurable battery states, such as internal resistance changes or chemical state alterations that are not directly measurable but can be inferred from other indicators.

The battery management system 104 also accesses and retrieves limit data 112 from its memory, which sets the operational boundaries for battery usage, such as maximum temperature and minimum voltage thresholds.

The limit data 112 may be dynamically updated based on predictive analytics that consider historical performance data and real-time operational conditions. This allows for adaptive management of the battery's charging and discharging processes to optimize battery life and performance.

At block 306, the aircraft 102 serializes the operational data using structured data serialization (e.g., using protocol buffers). The serialization is facilitated by the data transmitter 118 within the aircraft 102, which converts the collected operational data 106 into a compact binary format suitable for transmission over the one-way communication channel 120.

At a high level, the process at block 306 involves transforming the operational data 106 into a format that is streamlined for efficient transmission. This transformation is performed by the data transmitter 118, which packages the data into a structured format that is both lightweight and easy to transmit over communication networks. In more specific examples, the data transmitter 118 may use protocol buffers to encode the operational data 106, including using a schema that specifies the structure of the data, including the types of each field and how they are encoded. Protocol buffers provide a flexible and efficient method of structuring data that can evolve over time without breaking compatibility with older systems. Protocol buffers used in the serialization process at block 306 may employ varint encoding for integers, which uses an adaptive number of bytes depending on the size of the value, saving space when transmitting smaller numbers. Additionally, for transmitting arrays of data, such as sensor readings from multiple sensors, protocol buffers may use packed encoding, which consolidates multiple elements of the same type into a single key-length-value pair, reducing the overhead per element. This may be useful in scenarios where the aircraft 102 needs to send high volumes of sensor data 108 efficiently. The compact binary format produced is not only smaller in size but also faster to process by the battery ground support equipment (BGSE) 116, facilitating quicker response times and potentially more timely adjustments to the aircraft's operational parameters.

At block 308, the aircraft 102 transmits the serialized data over UDP. In some examples, the data transmitter 118 sends the serialized data through the one-way communication channel 120 to the battery ground support equipment (BGSE) 116.

At a high level, the process at block 308 involves the aircraft 102 sending the prepared data packets to the battery ground support equipment (BGSE) 116 using a communication protocol designed for rapid data transfer. In more specific examples, the data transmitter 118 uses the User Datagram Protocol (UDP) for sending the serialized data. UDP provides reduced overhead, as it does not require the establishment of a connection before data is sent, nor does it require acknowledgment of receipt, which can expedite the transmission process. This may be beneficial in aviation environments for timely data transmission

The transmission of serialized data over UDP at block 308 may further include mechanisms to enhance data integrity and manage data loss. Although UDP does not guarantee delivery, techniques such as adding sequence numbers to the packets can be employed. This allows the battery ground support equipment (BGSE) 116 to check for missing packets. Additionally, checksums may be used to verify the integrity of the data upon arrival, ensuring that the data has not been corrupted during transit.

At block 310, the BGSE 116 receives the serialized data. The data receiver 126 within the BGSE 116 may be responsible for capturing the incoming data packets transmitted by the aircraft.

Following this, at block 312, the data receiver 126 deserializes the data. This operation converts the serialized data back into a usable form, allowing the BGSE 116 to interpret the operational data accurately. Here, the data receiver 126 takes the compact, structured format of the incoming data and reconstructs it into a format that is readily interpretable by the systems within the BGSE 116.

In more specific examples, the deserialization process at block 312 is facilitated by the same or similar protocol buffers used for serialization. The data receiver 126 uses a predefined schema, which outlines the data's structure, to accurately decode the binary data into the original data types and structures. This might include converting compact binary representations of numbers, strings, and other data types back into their full representations as used within the BGSE's operational systems.

Further, the deserialization at block 312 may involve additional error-checking and correction processes to ensure the integrity of the data. The data receiver 126 may implement sequence checking to reorder any out-of-sequence packets and identify missing packets. Furthermore, checksum validation may be performed to detect any corruption that might have occurred during transmission.

At block 314, the charging controller 124, within the BGSE 116, interprets the operational data 106, which includes analyzing the deserialized data to determine (1) limit specifications of the limit data 112 and (2) operational conditions from the sensor data 108 and observer data 110 (e.g., the battery's current state and other relevant parameters).

At decision block 316, the BGSE 116 conducts a safety check. This operation assesses whether the charging parameters and the current state of the aircraft meet predefined safety criteria. If the safety check fails, as determined at block 316, the BGSE 116 activates safety interlock 122 at block 318, preventing the charging process from proceeding.

The safety check at decision block 316 may involve evaluations of both the charging parameters and the aircraft's current state against established safety thresholds. This includes verifying that the battery's temperature, voltage, and current are within safe operational limits as defined by the limit data 112.

Additionally, the BGSE 116 executes local observer algorithms 136 at block 336 and uses the battery models 132 to predict and evaluate conditions that are not directly measurable but useful for safe operation. The local observer algorithms 136 may predict the internal temperature of battery cells of the battery packs 140, based on external measurements and known thermal characteristics of the battery (e.g., included in the operational data 106). If the predicted internal temperatures exceed safe limits, even though external sensors show normal temperatures, the safety check will fail. Similarly, the battery model 132, which encapsulates the battery's charge acceptance and degradation characteristics, may indicate that the battery is approaching a critical state of wear or damage that could be exacerbated by further charging. This model-based approach allows for an estimate of battery health beyond what direct measurements can provide.

The BGSE 116 may incorporate real-time data analytics during the safety check at decision block 316. This can be done both locally on the battery ground support equipment (BGSE) 116 and in the cloud via the monitoring and control center 230.

Locally, the BGSE 116 may use machine learning algorithms to analyze trends in the battery's performance over time. These algorithms can identify subtle signs of potential failure that are not immediately obvious from static threshold checks. For example, the algorithms may detect an increasing trend in internal resistance, suggesting electrode degradation.

In the cloud, the monitoring and control center 230 can perform complex and computationally intensive analytics. This monitoring and control center 230 may aggregate data from multiple BGSE units and aircraft to identify broader patterns and trends. The cloud-based analytics can provide deep insights into battery health and performance across the entire fleet.

If these analytics, whether performed locally or in the cloud, indicate an emerging risk, the safety check will trigger a fail response.

If the safety check at decision block 316 determines that safety conditions are not met, the BGSE 116 activates the safety interlock 122 at block 318. These interlocks may be components that physically or electronically disconnect the charging apparatus of the BGSE 116 from the aircraft 102, ensuring that no charging occurs if there is any risk of battery damage or other safety hazards. For example, circuit breakers may trip if certain parameters are exceeded, or software controls that prevent the initiation of charging protocols.

In some examples, the activation of safety interlock 122 might also trigger additional diagnostic procedures to ascertain the cause of the safety check failure. This may involve data logging for later analysis or notifications to maintenance personnel for inspection and corrective action. This proactive diagnostic approach helps in not only preventing immediate hazards but also in mitigating potential future risks by addressing underlying issues before they lead to more serious consequences.

If the safety check passes at decision block 316, the method 300 proceeds to block 320, where the BGSE 116 determines the charging parameters based on the interpreted data. These parameters guide how the charging process should be conducted, including the rate and profile for charging.

In some examples, at block 320, the charging controller 124 uses algorithms to analyze the operational data 106, which includes current battery status, historical charging data, and real-time environmental conditions. This analysis is used in formulating charging strategies that seek to implement efficient charging and also prioritize the health and longevity of the aircraft's battery.

In more specific examples, the charging parameters determined by the charging controller 124 may include variable charging rates that adjust dynamically based on responses of the batteries 138 of the battery packs 140 during the charging process. For instance, if the battery packs 140 exhibit signs of stress, such as unexpected temperature rises or voltage drops, the charging controller 124 can automatically lower the charging rate to mitigate these effects. Conversely, if the battery packs 140 are performing well under initial charging conditions, the charging rate may be incrementally increased to shorten the overall charging time without compromising safety.

The duration of charging is another parameter set at block 320. This may involve using a prediction model that estimates the time required to reach a full charge based on the battery's current state and past performance under similar conditions. Such a model takes into account factors such as the battery's age, its historical efficiency in accepting charge, and even ambient temperature conditions, which can affect the charging process.

In some examples, the charging controller 124 integrates adaptive charging algorithms that learn from each charging session. These algorithms use machine learning techniques to refine their predictions and adjustments, making the charging process more efficient over time. For example, if the algorithms detect that the battery packs 140 consistently reach full charge faster than initially predicted, future charging durations might be adjusted accordingly to reduce downtime and improve turnaround times for the aircraft 102.

Additionally, the charging controller 124 employs safety margins in setting the charging parameters to ensure that, even if certain operational data points are near threshold levels, the charging process remains within a safe envelope. This may include setting slightly lower maximum voltage or temperature limits as a precautionary measure, especially in scenarios where the battery has shown signs of degradation.

At block 322, the charging controller 124 of the BGSE 116 executes the charging process. This operation involves the actual delivery of power to the aircraft's battery according to the determined charging parameters. At a high level, the charging process involves the controlled transfer of electrical energy to the aircraft's battery packs 140. The charging parameters, which have been previously determined based on various data inputs and observer models, guide the rate, timing, and intensity of the power delivery to ensure charging efficiency and battery health.

The execution of the charging process at block 322 may include the modulation of power output based on real-time feedback from the battery management system 104. For instance, if the temperature of a battery pack 140 approaches a threshold, the charging controller 124 may automatically reduce the charging rate to prevent overheating. Similarly, if the state of charge of a battery pack 140 nears full capacity, the charging rate might be tapered off to avoid overcharging, which can degrade battery health over time.

In some examples, the BGSE 116 executes algorithms to dynamically adjust the charging strategy during the execution phase. These algorithms may take into account not only the immediate data from the sensors (e.g., the sensor data 108 and sensor data 134) but also historical charging data and predictive models to optimize the charging process. For example, if the battery has shown a tendency to accept charge more efficiently at slightly lower temperatures, the BGSE 116 might activate additional cooling measures during charging to enhance the uptake of charge and extend the battery's lifespan. Additionally, the BGSE 116 may use pulse charging techniques, where power is delivered in pulses rather than a steady stream, to improve the absorption of charge and reduce stress on the battery cells.

From block 322, the method 300 progresses to decision block 324, where the charging controller 124 makes a determination about whether the charging process is complete. If so, the method 300 progresses to block 326, where the charging controller 124 ends the charging process.

Then, at block 328, the charging controller 124 logs data concerning the charging session.

In this phase of the process, the charging controller 124 undertakes a data logging activity that captures metrics from the charging session. This data is used to create records of each charging event and provides insights for ongoing operational analysis and system optimization.

The data logged by the charging controller 124 at block 328 may include a variety of parameters such as the total energy delivered during the session, the time duration of the charge, the peak and average voltage and current levels, and detailed temperature profiles of the battery throughout the charging process. Additionally, the charging controller 124 may record any anomalies or deviations from expected performance metrics, such as unexpected drops in voltage or spikes in temperature.

For instance, the charging controller 124 may use sensors integrated into the BGSE 116 to continuously monitor and log voltage levels at multiple points across the charging circuit. This could involve using high-precision voltage sensors that provide real-time data, which is then aggregated and stored in a structured time series format. Similarly, current sensors may measure the flow of electricity at various stages of the charging process, providing data that helps in assessing the efficiency of the charge transfer and the health of the battery.

Temperature data may be captured by thermocouples or infrared sensors deployed near components to monitor temperature fluctuations. This data is logged with timestamps to create a comprehensive thermal profile of each session.

Furthermore, the charging controller 124 might also log the status of various safety systems activated during the charging process, such as interlocks or circuit breakers.

Logged data is timestamped and may be encoded using data serialization techniques to minimize storage space while maintaining data integrity. This logged data is then either stored locally in a secure database or transmitted to a centralized data management system (e.g., monitoring and control center 230 and datastore 234), where it can be accessed for further analysis, used in predictive maintenance algorithms, or reviewed for compliance with regulatory standards.

Upon completion of the data logging at block 328, the method 300 moves to done block 330, marking the end of the charging session.

Returning to decision block 324, should the charging controller 124 determine at decision block 324 that the charging process is not complete, the method 300 advances to decision block 332.

At decision block 332, the BGSE 116 performs an evaluation to determine if the ongoing charging process aligns with the predefined charging parameters. This decision block 332 serves as a quality control operation to ensure that the charging is executed safely and efficiently.

If the charging controller 124 detects that the charging process deviates from the set parameters—such as exceeding temperature limits, charge rates, or voltage thresholds—it triggers a loop back to block 334 where adjustments can be made. This may involve recalibrating the power output, modifying the charge rate, or enhancing cooling measures to bring the charging process back within safe operational limits.

In some examples, the charging controller 124 uses real-time data monitoring and feedback mechanisms to continuously assess the charging status. If a parameter exceeds its safe range, the charging controller 124 automatically adjusts the charging strategy, employing algorithms that dynamically modify the charging based on real-time battery responses and environmental conditions.

If the charging process is confirmed to be within the established parameters, ensuring proper charging conditions and battery health, the charging controller 124 loops back to decision block 316 for a safety check.

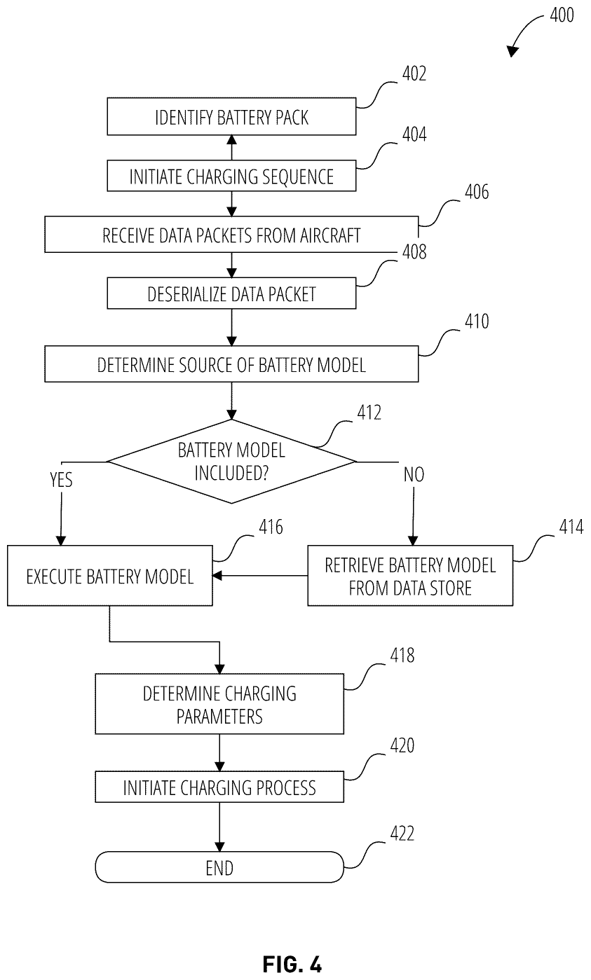

### FIG. 4

FIG. 4 illustrates a method 400 for managing aircraft charging systems, according to some examples. Although the example method 400 depicts a specific sequence of operations, this sequence may be modified without departing from the scope of the present disclosure. For instance, some operations depicted may be executed concurrently or in a different order that does not significantly impact the functionality of the method 400. In some examples, various components of a device or system implementing method 400 may perform functions simultaneously or in a specific sequence.

At block 402, a battery pack 140 of the aircraft 102 to be charged is identified. The aircraft 102 may have multiple battery packs 140 connected to the battery ground support equipment (BGSE) 116, and an arbitration process may be initiated to identify a specific battery pack 140 to be charged.

The method 400 includes initiating a charging sequence at block 404. For example, the battery ground support equipment (BGSE) 116 illustrated in FIG. 1 may initiate a charging sequence as follows:
Connection and Initial Check: When the aircraft connects to the BGSE 116 the BGSE 116 closes its contactors if there is no large voltage mismatch.
Arbitration Process: The BGSE 116 initiates an arbitration process by raising the voltage of its outputs to specific levels. It then confirms that these voltage levels are accurately read back from the aircraft's Battery Management System (BMS) 104.
Voltage Matching: The BGSE 116 adjusts the output voltage of each of its channels to match the voltage of the connected aircraft batteries.
Aircraft Contactor Closure: The aircraft's contactors close only after the voltage matching is complete, establishing the final connection for charging.

This sequence may provide a safe and controlled initiation of the charging process, reducing risks associated with voltage mismatches and ensuring proper communication between the BGSE and the aircraft systems.

At block 406 of the method 400, the BGSE 116 receives transmitted data packets from the aircraft 102. This process is facilitated by the data receiver 126, as depicted in FIG. 1. The aircraft 102 transmits these packets using a one-way communication channel 120, supporting a protocol such as UDP, which enhances security by reducing the risk of unauthorized access and interference, as the aircraft 102 does not receive or expect to receive direct feedback or commands from the BGSE 116 through the same one-way communication channel 120.

The data transmitted may be streamed continuously, providing the charging controller 124 with real-time updates on the aircraft's operational status. This continuous flow of data enables the charging controller 124 to make determinations regarding the charging process, ensuring that actions are based on current data.

The types of data transmitted in these packets may include:
Limit data 112: This includes information about the operational limits of the aircraft 102, such as temperature and charge limits. Within this category, the charge curve data 114 is also transmitted, which specifies charging rates based on the battery's current state of charge.
Sensor data 108: The packets also contain sensor data 108, which provides real-time measurements from various sensors on the aircraft. This includes observer data 110, which is derived from observer models that predict unmeasurable (or hard-to-measure) states of the aircraft's systems.
Other Operational Data: Additional operational data transmitted may include information regarding the aircraft's current status, upcoming maintenance schedules, and other relevant operational details that may influence the charging process.
Model Data: The data packets transmitted to the battery ground support equipment (BGSE) 116 may include model data, which encompasses either the actual code or algorithms of specific battery models or descriptions or identifiers of models pertinent to the aircraft's battery and charging systems. In some instances, this identifier information comprises the aircraft's identifier, or its make and model. This allows the battery ground support equipment (BGSE) 116 to accurately identify the appropriate battery model and subsequently download the necessary model(s) from a remote datastore (e.g., datastore 234) or resource.

This model data 130 enables the battery ground support equipment (BGSE) 116 to retrieve and execute local battery models 132 within the charging controller 124. By using the output from these battery models 132, the charging controller 124 can control and optimize the charging session, ensuring that the charging process is not only efficient but also tailored to the specific requirements of the aircraft's battery system.

At block 408 in method 400, the data receiver 126 deserializes data packets received from the aircraft 102.

The data receiver 126 starts deserialization upon receiving the serialized data packets, typically sent via UDP. The deserialization involves parsing the structured data according to predefined schemas. These schemas ensure the data is interpreted correctly and consistently, maintaining the integrity and accuracy of the information received.

During deserialization, the data receiver 126 extracts the operational data 106 such as battery status and charging requirements, and other identifiers or metadata that help the battery ground support equipment (BGSE) 116 customize the charging process, such as the aircraft model or battery type.

At block 410, the charging controller 124 determines the source of the battery model 132, which may be used in setting the charging parameters. The source may either be the transmitted data itself from the aircraft 102 or a remote resource such as datastore 234.

In some examples, the charging controller 124 employs algorithms to analyze the headers or metadata of the incoming data packets to ascertain whether they contain complete battery model information. If the data packets only include identifiers or partial data, the BGSE 116 then accesses a remote database, such as datastore 234, using a secure communication protocol. This datastore 234 may host a variety of battery models and configurations, allowing the BGSE 116 to download the specific model relevant to the aircraft in question.

At decision block 412, the charging controller 124 assesses whether the battery model 132 itself was included within the transmitted data. If the battery model 132 is included, method 400 advances to block 416, where the charging controller 124 executes the battery model 132.

Conversely, if the battery model is not found within the transmitted data, which is determined to include appropriate meta or identifier information, the method 400 moves to block 414. Here, the battery ground support equipment (BGSE) 116 retrieves the battery model 132 from a remote resource, such as datastore 234 or another external source, using the identifier information.

After retrieving the battery model 132 at block 414, the method 400 proceeds to block 416, where the charging controller 124 executes the battery model.

At block 418, the charging controller 124 engages in a process to determine the charging parameters. This process may involve executing one or more battery models 132 to derive approximations or estimates of the conditions of the battery packs 140 of the aircraft 102.

Finally, at block 420, the charging controller 124 initiates the charging process, as outlined in FIG. 3. Following this, method 400 concludes at done block 422, marking the end of the charging sequence. This structured approach ensures that the charging parameters are meticulously calculated and applied, leading to an effective and tailored charging operation for the aircraft.

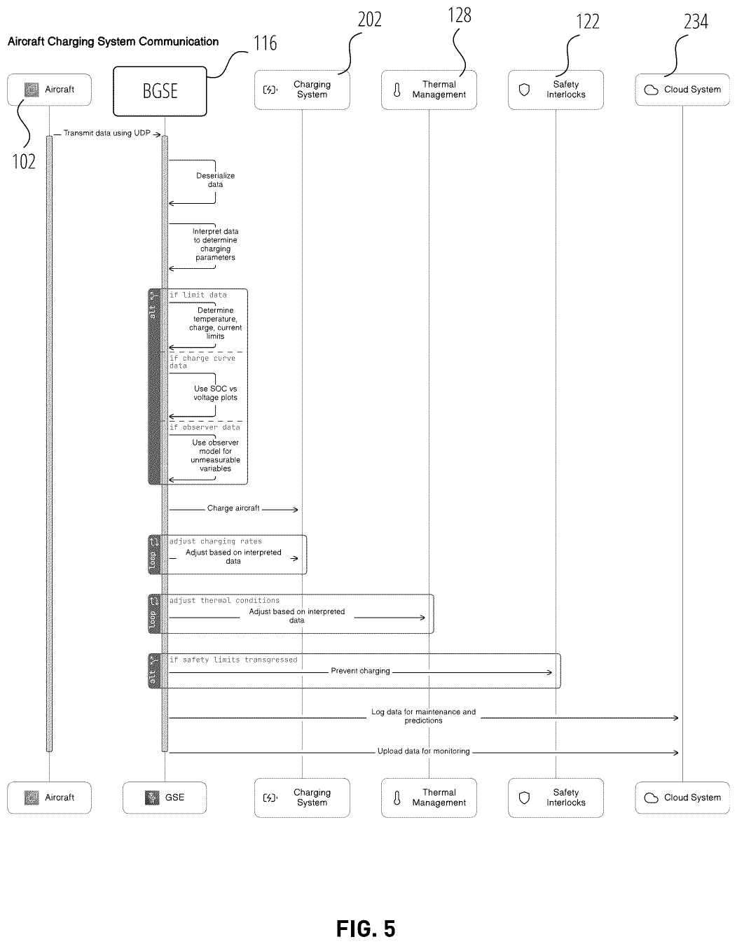

### FIG. 5

FIG. 5 is an interaction diagram that details the interactions among the different components and systems discussed in the preceding figures. Specifically, it shows components labeled as aircraft 102, battery ground support equipment (BGSE) 116, charger 202, thermal conditioning system 128, interlock 122, and datastore 234.

The diagram illustrates the transmission of data using UDP between the aircraft 102 and battery ground support equipment (BGSE) 116, including the deserialization and interpretation of this data by the battery ground support equipment (BGSE) 116.

Additionally, operations carried out by the BGSE 116 involve determining whether the transmitted data includes limit data, charge curve data, and observer data. The BGSE 116 adjusts charging rates using the charging controller 124 and controls the thermal conditioning system 128 to adjust thermal conditions based on the interpreted data extracted from the transmitted operational data from the aircraft.

If safety limits are exceeded, the BGSE 116 activates interlock 122. The BGSE 116 also logs data about the charging process within a datastore 234 for maintenance and predictive purposes. Furthermore, the battery ground support equipment (BGSE) 116 can upload data to a remote monitoring service for monitoring.

Each of the operations shown in FIG. 5 can be performed continuously. The diagram does not indicate any specific order or intermittent performance of these operations.

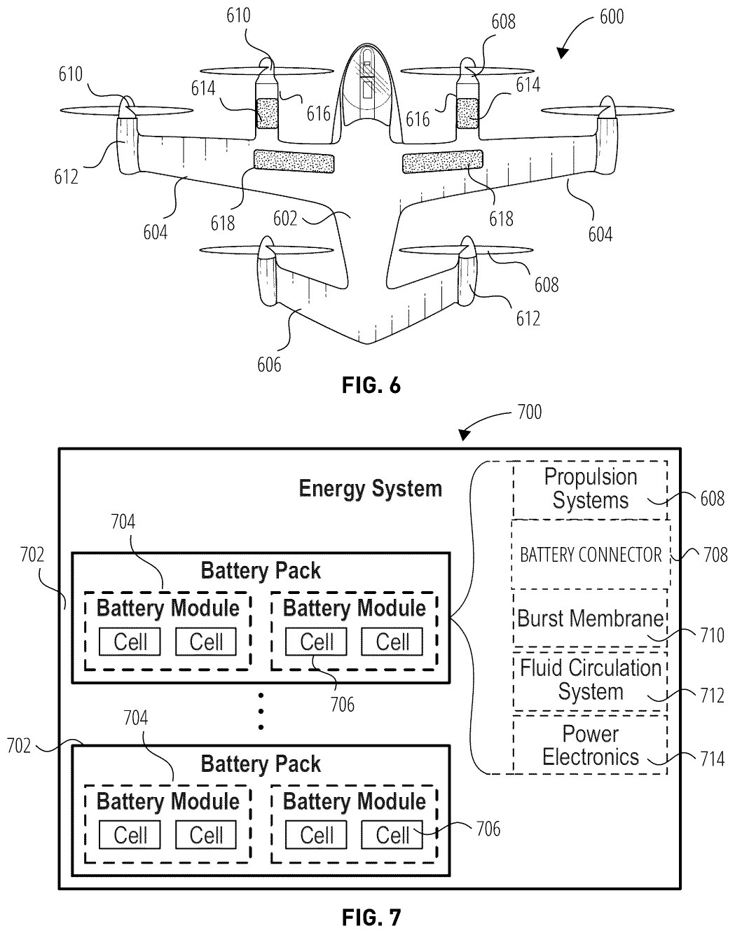

### FIG. 6: VTOL Aircraft and Energy Storage System Overview

FIG. 6 is a top view of a specific type of aircraft 102, a VTOL (Vertical Take-Off and Landing) aircraft 600, according to some examples. The aircraft 600 is composed of several parts, including a fuselage 602, two wings 604, an empennage 606, and propulsion systems 608. The propulsion systems 608 are uniquely embodied as tiltable rotor assemblies 610, strategically located in nacelles 612. This configuration allows the aircraft 600 to take off and land vertically, thereby providing operational flexibility and enabling the aircraft 600 to operate in a wide range of environments.

The fuselage 602 forms the main body of the aircraft 600, housing the cockpit, passenger cabin, and cargo hold. It is designed to withstand the various structural stresses that the aircraft may encounter during flight, such as aerodynamic forces, gravitational forces, propulsive forces, external point loads, distributed loads, and body forces, among others.

The wings 604 of the aircraft 600 serve a dual purpose. Primarily, they generate lift to support the aircraft 600 during forward flight. However, they also play a structural role, providing support to the battery packs 702 (FIG. 7), battery module 704 (FIG. 7), and/or propulsion systems 608. This structural support is particularly valuable given the various structural stresses the aircraft 600 may encounter during flight.

The empennage 606, or tail assembly, of the aircraft 600 provides stability during flight. It includes the vertical stabilizer and horizontal stabilizer, which control the aircraft's yaw and pitch, respectively. The empennage 606 also houses control surfaces such as the rudder and elevators, which are used to steer the aircraft 600 during flight.

The propulsion systems 608 of the aircraft 600 include tiltable rotor assemblies 610 located in nacelles 612. These rotor assemblies 610 provide the thrust that propels the aircraft 600 during flight. The ability to tilt the rotor assemblies 610 allows the aircraft 600 to transition between vertical and horizontal flight, thereby enhancing its operational flexibility.

In the given illustration, nacelle battery packs 614 are situated in inboard nacelles 616, and wing battery packs 618 are situated in the wings 604. The placement of these battery packs 614 is not fixed, and they could potentially be located in other nacelles 612 that form part of the aircraft 600. This flexibility in the placement of the battery packs 614 allows for efficient distribution and integration of the power sources within the aircraft structure, thereby enhancing the overall performance and efficiency of the aircraft 600.

### FIG. 7: Aircraft Energy Storage System

FIG. 7 provides a schematic view of an aircraft energy storage system 700, according to some examples. This energy storage system 700 is managed by a power distribution system that oversees the storage and distribution of electrical energy on the aircraft. The energy storage system 700 is designed to store and supply power to the various systems of the aircraft 600, including the propulsion systems, avionics, and auxiliary systems.

The energy storage system 700 includes one or more battery packs 702. Each battery pack 702 is a modular unit that can be independently managed and serviced. This modular design enhances the flexibility and maintainability of the energy storage system 700. Each battery pack 702 may include one or more battery modules 704, which in turn may comprise a number of cells 706. These cells 706 are the basic units of energy storage within the battery pack 702.

Typically associated with a battery pack 702 are one or more propulsion systems 608. These propulsion systems 608 draw power from the battery packs 702 to generate thrust for the aircraft. A battery pack 702 is connected to the energy storage system 700 via a battery connector 708, which facilitates the transfer of electrical power between the battery pack 702 and the other components of the energy storage system 700.

Each battery pack 702 also includes a burst membrane 710 as part of a venting system. This venting system is designed to release gases from the battery pack 702 in a controlled manner, thereby preventing the build-up of pressure within the battery pack 702 that could lead to damage or failure of the aircraft 600.

The energy storage system 700 also includes a fluid circulation system 712 for heating and cooling. This cooling system circulates a working fluid within the battery pack 702 to remove heat generated by the battery pack 702 during operation or charging.

Power electronics 714 are also associated with each battery pack 702. These power electronics 714 regulate the delivery of electrical power from the battery pack 702 during operation and to the battery during charging. They also provide integration of the battery pack 702 with the electronic infrastructure of the energy storage system 700.

The propulsion systems 608 associated with the battery pack 702 may comprise multiple rotor assemblies. These rotor assemblies generate thrust for the aircraft by rotating at high speeds. They draw power from the battery pack 702 and are controlled by the aircraft's flight control system to achieve the desired flight characteristics.

The electronic infrastructure and the power electronics 714 can function to integrate the battery packs 702 into the energy storage system 700 of the aircraft. The electronic infrastructure can include a battery management system (BMS), power electronics (high-voltage HV architecture, power components, and so forth), low-voltage (LV) architecture (e.g., vehicle wire harness, data connections, and so forth), and/or any other suitable components.

The electronic infrastructure can include inter-module electrical connections, which can transmit power and/or data between battery packs and/or modules. Inter-modules can include bulkhead connections, bus bars, wire harnessing, and/or any other suitable components.

The battery packs 702 function to store electrochemical energy in a rechargeable manner for supply to the propulsion systems 608. Battery packs 702 can be arranged and/or distributed around the aircraft in any suitable manner. Battery packs can be arranged within wings (e.g., inside of an airfoil cavity), inside nacelles, and/or in any other suitable location on the aircraft. In a specific example, the energy storage system 700 includes a first battery pack within an inboard portion of a left wing and a second battery pack within an inboard portion of a right wing. In a second specific example, the system includes a first battery pack within an inboard nacelle of a left wing and a second battery pack within an inboard nacelle of a right wing. Battery packs 702 may include a plurality of battery modules 704.

The energy storage system 700 includes a cooling system (e.g., fluid circulation system 712) that functions to circulate a working fluid within the battery pack 702 to remove heat generated by the battery pack 702 during operation or charging. Battery cells 706, battery module 704 and/or battery packs 702 can be fluidly connected by the cooling system in series and/or parallel in any suitable manner.

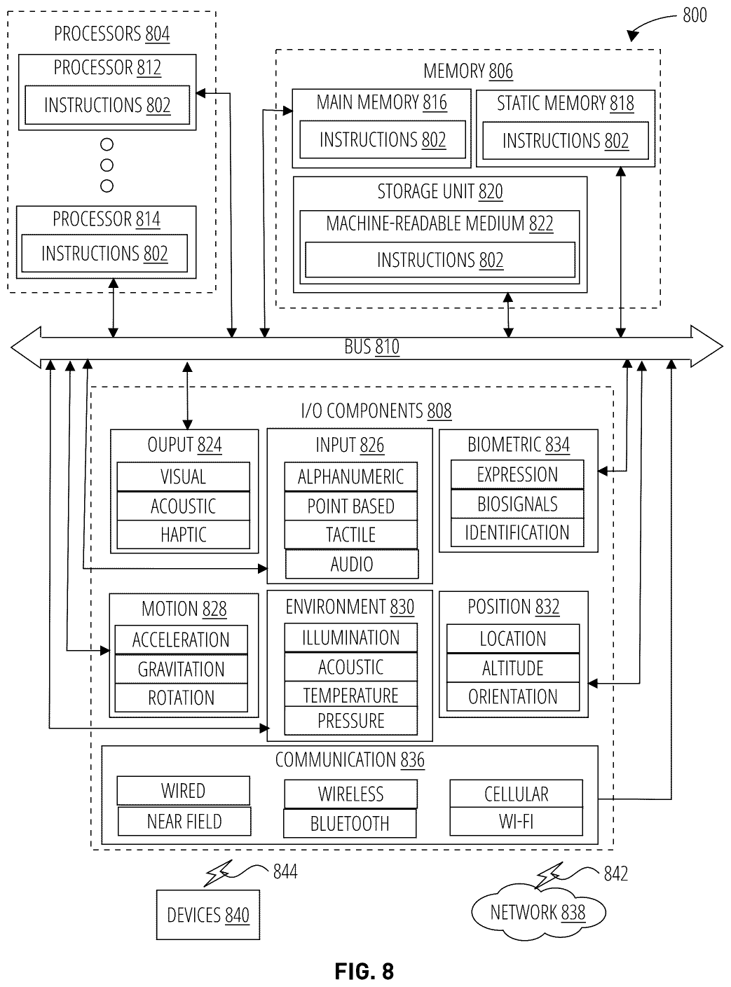

### FIG. 8: Computer System

FIG. 8 shows a diagrammatic representation of the machine 800 in the example form of a computer system within which instructions 802 (e.g., software, a program, an application, an applet, an app, or other executable code) for causing the machine 800 to perform any one or more of the methodologies discussed herein may be executed. The machine 800 may for example, for part of the charging controller 124 of the battery ground support equipment (BGSE) 116 or the battery management system 104 of the aircraft 102.

The instructions 802 may transform the general, non-programmed machine 800 into a particular machine 800 programmed to carry out the described and illustrated functions in the manner described. In alternative examples, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. Further, while only a single machine 800 is illustrated, the term “machine” shall also be taken to include a collection of machines 800 that individually or jointly execute the instructions 802 to perform any one or more of the methodologies discussed herein.

The machine 800 may include processors 804, memory 806, and I/O components 808, which may be configured to communicate with each other such as via a bus 810. In an example, the processors 804 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 812 and a processor 814 that may execute the instructions 802. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single core, a single processor with multiple cores (e.g., a multi-core processor), multiple processors with a single core, multiple processors with multiples cores, or any combination thereof.

The memory 806 may include a main memory 816, a static memory 818, and a storage unit 820, both accessible to the processors 804 such as via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones will likely include a touch input device or other such input mechanisms, while a headless server machine will likely not include such a touch input device. It will be appreciated that the I/O components 808 may include many other components that are not shown in FIG. 8. The I/O components 808 are grouped according to functionality merely to simplify the following discussion and the grouping is in no way limiting. In various examples, the I/O components 808 may include output components 824 and input components 826. The output components 824 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 808 may include biometric components 828, motion components 828, environmental components 830, or position components 832, among a wide array of other components. For example, the biometric components 834 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 828 may include acceleration sensor components (e.g., accelerometer), gravitation sensor components, rotation sensor components (e.g., gyroscope), and so forth. The environmental components 830 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 832 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 808 may include communication components 836 operable to couple the machine 800 to a network 838 or devices 840 via a coupling 842 and a coupling 844, respectively. For example, the communication components 836 may include a network interface component or another suitable device to interface with the network 838. In further examples, the communication components 836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 840 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

### Executable Instructions Machine Storage Medium

The various memories (i.e., memory 806, main memory 816, static memory 818, and/or memory of the processors 804) and/or storage unit 820 may store data, such as a battery model, one or more sets of instructions and data structures embodying or utilized by any one or more of the methodologies or functions described herein. These instructions and models (e.g., the instructions 802), when executed by processors 804, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 838 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 838 or a portion of the network 838 may include a wireless or cellular network, and the coupling 842 may be a Code Division Multiple Access (CDMA) connection, a Global System for Mobile communications (GSM) connection, or another type of cellular or wireless coupling. In this example, the coupling 842 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 802 may be transmitted or received over the network 838 using a transmission medium via a network interface device (e.g., a network interface component included in the communication components 836) and utilizing any one of a number of well-known transfer protocols (e.g., hypertext transfer protocol (HTTP)). Similarly, the instructions 802 may be transmitted or received using a transmission medium via the coupling 844 (e.g., a peer-to-peer coupling) to the devices 840. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 802 for execution by the machine 800, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium”mean the same thing and may be used interchangeably in this disclosure. The terms are defined to include both machine-storage media and transmission media. Thus, the terms include both storage devices/media and carrier waves/modulated data signals.

### Data Logging

In some examples, the battery ground support equipment (BGSE) 116 logs operational data received from aircraft. This data includes various parameters such as battery status, charge levels, and temperature readings. The data is transmitted efficiently using protocol buffers over UDP, ensuring that it is both fast and reliable.

Upon receiving this data, the BGSE 116 begins the process of deserialization, converting the serialized data back into a usable form. This deserialized data is then logged in a structured format within the BGSE's data management system, with each piece of data carefully timestamped. This allows for the creation of a detailed chronological record of the battery's status and performance over time.

The logged data may be used for predictive maintenance strategies. By analyzing trends and patterns in this data, the BGSE 116 may proactively identify potential failures or maintenance needs before they escalate into more significant issues. For instance, a gradual increase in the battery's operating temperature over several charging cycles might indicate a deteriorating battery health, prompting preemptive maintenance actions.

Moreover, the logged data may be used in predicting the lifetime of the aircraft's battery. Algorithms and machine learning models assess the battery's degradation rate by analyzing various factors such as charge cycles, depth of discharge, and temperature fluctuations. This analysis may be helpful for scheduling battery replacements at optimal intervals and managing warranty claims effectively.

Additionally, this logged data may be periodically uploaded to a central monitoring and control center via a secure network. This centralization allows for broader analytics and cross-referencing with data from other aircraft, which enhances the accuracy of predictive maintenance and lifetime prediction models. Furthermore, this centralized data repository plays a role in regulatory compliance and facilitates continuous improvement of battery management practices across the fleet.

### Multiple Aircraft

In some examples, the battery ground support equipment (BGSE) 116 is configured to manage the charging of multiple aircraft simultaneously. Each aircraft transmits operational data to the BGSE using a one-way communication protocol.

As each aircraft sends its operational data, the BGSE 116 receives and processes this information individually. This data may include battery status, charge requirements, and other parameters necessary for charging management. The one-way nature of the communication protocol means that while the aircraft can send data to the BGSE, they do not receive any data in return. This setup enhances the system's security, reducing the risk of unauthorized access or manipulation of the aircraft's systems via the BGSE 116

The ability of the BGSE 116 to handle multiple aircraft simultaneously does not merely streamline operations but also optimizes the use of resources. By managing several charging processes at once, the BGSE 116 can effectively allocate power where it is needed most, adjusting charging rates in real-time based on the specific needs and battery conditions of each aircraft. This dynamic management may help in reducing bottlenecks and improving the turnaround time for aircraft waiting to be charged.

Moreover, this system's design considers the varying software versions or configurations that different aircraft might have. The charging controller 124 can interpret the diverse data formats and charging requirements of different aircraft models, and provide the appropriate charge without the need for manual recalibration or extensive reconfiguration of the system for each new aircraft type.

### Example Technical Problems and Solutions

### Data Security Risks in Aircraft Systems:

Brief Description: Traditional two-way communication systems may expose aircraft systems to potential unauthorized access and control, posing significant security risks.
Technical Solution: In some examples, the one-way communication protocol may enhance security by removing the possibility of sending data to the aircraft. This reduces the risk of unauthorized access or control of the aircraft systems via the BGSE 116). The technology ensures that the aircraft only functions as a sender of information, while the BGSE 116 operates exclusively as a receiver. This approach may also simplify communication processes and enhance security by reducing potential attack vectors that could be exploited through bidirectional communication systems.

### Complexity and Reliability of Data Transmission:

Brief Description: Two-way communication systems often require complex handshaking and error correction mechanisms, which can introduce delays and synchronization issues.
Technical Solution: In some examples, the one-way communication protocol uses a data transmission method that does not require handshaking or confirmation from the BGSE 116. This method allows the aircraft to continuously broadcast its status and requirements without waiting for responses, which may be advantageous in busy airport environments where delays can lead to operational inefficiencies. The BGSE 116, equipped with appropriate algorithms, interprets this incoming data to make autonomous decisions about charging parameters, ensuring charging strategies are applied based on the aircraft's current state and operational data.

### Interoperability and Backward Compatibility:

Brief Description: In aviation, different aircraft and BGSE 116 might use different software versions, which can lead to compatibility issues.
Technical Solution: In some examples, Proto Buffers over UDP may be used, which supports backward compatibility. This feature allows the BGSE 116 to interpret data from aircraft with different software versions without miscommunication. The structured data serialization of Protobuf allows for the definition of optional fields, ensuring that newer versions of the protocol can communicate with older versions without data loss.

### EXAMPLE STATEMENTS

In view of the disclosure above, various examples are set forth below. It should be noted that one or more features of an example, taken in isolation or combination, should be considered within the disclosure of this application.

Example 1 is a method for managing aircraft charging, comprising: receiving, by battery ground support equipment (BGSE), operational data transmitted from an aircraft via a one-way communication channel; interpreting, by the BGSE, the received operational data to autonomously determine charging parameters for the aircraft; and charging the aircraft based on the determined charging parameters without sending data to the aircraft.

In Example 2, the subject matter of Example 1, wherein the operational data includes limit data specifying at least one of temperature limits, charge limits, voltage, and current limits.

In Example 3, the subject matter of any one or more of Examples 1-2, wherein the limit data is dynamically adjusted by the aircraft based on real-time conditions of an aircraft battery.

In Example 4, the subject matter of any one or more of Examples 1-3, wherein the limit data further includes charge curve data representing charging rates based on a state of charge of an aircraft battery.

In Example 5, the subject matter of any one or more of Examples 1-4, wherein the operational data further includes sensor data obtained from the aircraft.

In Example 6, the subject matter of any one or more of Examples 1-5, wherein the sensor data comprises observer data derived from an observer algorithm predicting unmeasurable states of an aircraft battery.

In Example 7, the subject matter of any one or more of Examples 1-6, wherein the observer data is used by the BGSE to adjust the charging parameters.

In Example 8, the subject matter of any one or more of Examples 1-7, wherein the one-way communication channel utilizes a standardized data format enabling interoperability across multiple types of aircraft.

In Example 9, the subject matter of any one or more of Examples 1-8, further comprising logging the operational data for predictive maintenance of an aircraft battery.

In Example 10, the subject matter of any one or more of Examples 1-9, wherein the BGSE is to charge multiple aircraft simultaneously, each aircraft transmitting operational data via the one-way communication channel.

In Example 11, the subject matter of any one or more of Examples 1-10, wherein the BGSE is further to adjust thermal conditions of the aircraft during a charging process based on the operational data.

In Example 12, the subject matter of any one or more of Examples 1-11, wherein the charging parameters include a charging power level and a charging duration, each dynamically adjusted based on a current state of charge and battery health status of the aircraft as determined from the operational data.

In Example 13, the subject matter of any one or more of Examples 1-12, wherein the charging parameters further include a charging sequence that involves varying a charging rate at predetermined intervals.

In Example 14, the subject matter of any one or more of Examples 1-13, wherein the charging parameters are adjusted in real time in response to changes in external environmental conditions detected by sensors, the environmental conditions including at least one of temperature or humidity.

In Example 15, the subject matter of any one or more of Examples 1-14, wherein the operational data further includes observer data, and wherein the BGSE is configured to use the observer data to predict unmeasurable states of an aircraft battery.

In Example 16, the subject matter of any one or more of Examples 1-15, wherein the BGSE is configured to adjust the charging parameters based on real-time environmental conditions detected by sensors on the aircraft, the environmental conditions including at least one of temperature or humidity.

In Example 17, the subject matter of any one or more of Examples 1-16, wherein the BGSE includes a thermal management system configured to adjust thermal conditions during a charging process based on the interpreted data.

In Example 18, the subject matter of any one or more of Examples 1-17, wherein the BGSE is configured to log the transmitted operational data for predictive maintenance and lifetime predictions of an aircraft battery.

In Example 19, the subject matter of any one or more of Examples 1-18, wherein the BGSE is configured to upload the transmitted operational data to a cloud-based system for monitoring.

In Example 20, the subject matter of any one or more of Examples 1-19, wherein the BGSE is configured to execute a battery model applicable to the aircraft to optimize charging.

In Example 21, the subject matter of Example 20, wherein the battery model is received from the aircraft.

In Example 22, the subject matter of Example 20, wherein the battery model is retrieved from a data store based on aircraft identification information received from the aircraft.

Example 23 is a method to manage aircraft charging at a battery ground support equipment (BGSE), the method comprising: receiving, by the BGSE, battery model data from an aircraft via a one-way communication protocol, the battery model data associated with a battery model for at least one battery of the aircraft; determining, by the BGSE, charging parameters for the aircraft using the battery model data; and charging the aircraft based on the determined charging parameters.

In Example 24, the subject matter of Example 23, wherein the battery model data includes a battery model identifier, and the BGSE retrieves the battery model from a datastore based on the identifier.

In Example 25, the subject matter of any one or more of Examples 23-24, wherein the battery model data is received as part of operational data that also includes limit data and sensor data.

In Example 26, the subject matter of any one or more of Examples 23-25, wherein the battery model is used by the BGSE to predict battery performance during a charging process.

In Example 27, the subject matter of any one or more of Examples 23-26, wherein the BGSE adjusts the charging parameters dynamically during a charging process based on real-time feedback derived from the battery model.

In Example 28, the subject matter of any one or more of Examples 23-27, wherein the BGSE updates a charging strategy based on historical data comparisons with previously received battery model data.

In Example 29, the subject matter of any one or more of Examples 23-28, wherein the BGSE uses the battery model to perform a safety check before initiating charging.

In Example 30, the subject matter of any one or more of Examples 23-29, wherein the BGSE configures safety interlocks based on thresholds determined from the battery model.

In Example 31, the subject matter of any one or more of Examples 23-30, wherein the BGSE communicates with a central management system to report the receipt and utilization of the battery model data.

In Example 32, the subject matter of any one or more of Examples 23-31, wherein the BGSE uses the battery model data to perform thermal management during a charging process.

In Example 33, the subject matter of any one or more of Examples 23-32, wherein the BGSE performs error detection and correction on the received battery model data.

In Example 34, the subject matter of any one or more of Examples 23-33, wherein the BGSE uses the battery model to estimate the remaining life of the aircraft battery.

In Example 35, the subject matter of any one or more of Examples 23-34, wherein the BGSE adjusts the charging parameters in response to environmental conditions reported in conjunction with the battery model data.

In Example 36, the subject matter of any one or more of Examples 23-35, wherein the BGSE supports charging multiple aircraft simultaneously using respective battery model data received from each aircraft.

Example 37 is a system for managing power transfer to an aircraft, comprising: a receiver configured to obtain data from the aircraft through a unidirectional communication link; a processor configured to analyze the obtained data and determine power transfer parameters; and a power transfer unit configured to supply power to the aircraft based on the determined power transfer parameters without transmitting data to the aircraft.

In Example 38, the subject matter of Example 37, wherein the obtained data includes operational limits for at least one of temperature, charge, voltage, or current.

In Example 39, the subject matter of any one or more of Examples 37-38, wherein the obtained data includes sensor readings from the aircraft.

In Example 40, the subject matter of any one or more of Examples 37-39, wherein the processor is further configured to execute a predictive model to estimate non-measurable conditions of an aircraft power storage device based on the obtained data.

In Example 41, the subject matter of any one or more of Examples 37-40, wherein the unidirectional communication link utilizes a protocol that enables compatibility with various aircraft types.

In Example 42, the subject matter of any one or more of Examples 37-41, further comprising a data logger configured to record the obtained data for maintenance forecasting.

In Example 43, the subject matter of any one or more of Examples 37-42, wherein the power transfer unit is configured to simultaneously supply power to multiple aircraft, each aircraft transmitting data via the unidirectional communication link.

In Example 44, the subject matter of any one or more of Examples 37-43, further comprising a thermal management unit configured to regulate thermal conditions during power transfer based on the obtained data.

In Example 45, the subject matter of any one or more of Examples 37-44, wherein the processor is configured to dynamically adjust the power transfer parameters based on real-time environmental data received from the aircraft.

In Example 46, the subject matter of any one or more of Examples 37-45, wherein the processor is configured to execute a power storage device model to optimize the power transfer.

Example 47 is a method for managing power transfer to an aircraft, comprising: receiving data from the aircraft via a unidirectional communication channel; processing the received data to determine power transfer parameters; and initiating power transfer to the aircraft based on the determined power transfer parameters without transmitting data to the aircraft.

In Example 48, the subject matter of Example 47, wherein the received data includes a power storage device model identifier, and the method further comprises retrieving a corresponding power storage device model from a database.

In Example 49, the subject matter of any one or more of Examples 47-48, wherein the received data includes operational limits and sensor readings.

In Example 50, the subject matter of any one or more of Examples 47-49, further comprising predicting power storage device performance during power transfer using the power storage device model.

In Example 51, the subject matter of any one or more of Examples 47-50, further comprising dynamically adjusting the power transfer parameters during the power transfer based on feedback derived from the power storage device model.

In Example 52, the subject matter of any one or more of Examples 47-51, further comprising updating a power transfer strategy based on historical data comparisons with previously received power storage device model data.

Example 53 is a non-transitory computer-readable medium storing instructions that, when executed by a processor, cause the processor to perform operations comprising: receiving operational data from an aircraft via a one-way communication protocol; interpreting the received operational data to determine power transfer parameters for the aircraft; and initiating power transfer to the aircraft based on the determined power transfer parameters without transmitting data to the aircraft.

In Example 54, the subject matter of Example 53, wherein the operations further comprise executing a power storage device model to predict unmeasurable states of an aircraft power storage device.

In Example 55, the subject matter of any one or more of Examples 53-54, wherein the operations further comprise logging the received operational data for predictive maintenance and lifespan estimation of the aircraft power storage device.

In Example 56, the subject matter of any one or more of Examples 53-55, wherein the operations further comprise uploading the received operational data to a remote monitoring system.

What is claimed is:

1. A method for managing charging of an electric aircraft, comprising:
receiving, by ground support equipment, operational data transmitted from an aircraft via a one-way communication channel, the operational data including at least one of sensor data and limit data;
interpreting, by the ground support equipment, the received operational data to autonomously determine charging parameters for the electric aircraft; and
charging the electric aircraft based on the determined charging parameters, wherein the ground support equipment does not transmit data via the one-way communication channel to the electric aircraft.

2. The method of claim 1, wherein the operational data further comprises battery model data, and the ground support equipment retrieves a corresponding battery model from a datastore based on a battery model identifier.

3. The method of claim 1, wherein the operational data is serialized using a predetermined data format, and the one-way communication channel uses a connectionless protocol.

4. The method of claim 1, wherein the ground support equipment is configured to simultaneously receive and process operational data from a plurality of aircraft, each transmitting via a respective one-way communication channel.

5. The method of claim 1, further comprising, by the ground support equipment, autonomously performing a safety check based on the received operational data before initiating a charging process.

6. The method of claim 1, further comprising logging, by the ground support equipment, the received operational data and charging session metrics for at least one of predictive maintenance or battery lifetime estimation.

7. The method of claim 1, wherein the limit data includes at least one of temperature limits, charge limits, voltage limits, or current limits, and the sensor data comprises observer data derived from an algorithm predicting unmeasurable states of an aircraft battery.

8. The method of claim 1, wherein the ground support equipment includes a thermal management system configured to adjust thermal conditions of a battery of the electric aircraft during charging, based on the operational data.

9. The method of claim 1, wherein the charging parameters include a charging power level and a charging duration, each dynamically adjusted based on a current state of at least one of charge or battery health status as determined from the operational data.

10. The method of claim 1, wherein the ground support equipment uploads the received operational data to a remote monitoring system.

11. An apparatus for managing charging of an electric aircraft, comprising:
a receiver configured to obtain operational data from the electric aircraft via a one-way communication channel, the operational data including at least sensor data and limit data;
a processor configured to interpret the operational data and autonomously determine charging parameters for the electric aircraft; and
a charging unit configured to charge the electric aircraft based on the determined charging parameters,
wherein the apparatus is configured such that no data or commands are transmitted to the electric aircraft during a charging process.

12. The apparatus of claim 11, wherein the operational data further comprises battery model data, and the processor is configured to retrieve a corresponding battery model from a datastore based on a battery model identifier, based on a complete mode not being included in the battery model data.

13. The apparatus of claim 11, wherein the receiver is configured to receive the operational data in a structured data format, and the one-way communication channel utilizes a connectionless protocol.

14. The apparatus of claim 11, wherein the receiver is configured to simultaneously obtain operational data from a plurality of aircraft, each transmitting via a respective one-way communication channel.

15. The apparatus of claim 11, wherein the processor is further configured to autonomously perform safety checks based on the received operational data before initiating the charging process.

16. The apparatus of claim 11, further comprising a data logger configured to record the received operational data and charging session metrics for predictive maintenance or battery lifetime estimation.

17. The apparatus of claim 11, wherein the limit data includes at least one of temperature limits, charge limits, voltage limits, or current limits, and the sensor data comprises observer data derived from an algorithm predicting unmeasurable states of an aircraft battery.

18. The apparatus of claim 11, further comprising a thermal management system configured to adjust thermal conditions of a battery of the electric aircraft during the charging process, based on the operational data.

19. The apparatus of claim 11, wherein the charging parameters include a charging power level and a charging duration, each dynamically adjusted based on at least one of a current state of charge and a battery health status as determined from the operational data.

20. A non-transitory computer-readable medium storing instructions that, when executed by a processor, cause the processor to perform operations comprising:
receiving operational data from an aircraft via a one-way communication channel, the operational data including at least sensor data and limit data;
interpreting the received operational data to autonomously determine charging parameters for the aircraft; and
controlling a charging unit to charge of least one battery of the aircraft based on the determined charging parameters, wherein no data or commands are transmitted to the aircraft during charging.
